(19) United States
(12) Patent Application Publication
(10) Pub. No.: US 2015/0084897 A1
(43) Pub. Date: Mar. 26, 2015

(54) SYSTEM AND METHOD FOR FIVE PLUS ONE DEGREE-OF-FREEDOM (DOF) MOTION TRACKING AND VISUALIZATION

(71) Applicants: Gabriele Nataneli, Los Angeles, CA (US); Eric Savitsky, Malibu, CA (US)

(72) Inventors: Gabriele Nataneli, Los Angeles, CA (US); Eric Savitsky, Malibu, CA (US)

(21) Appl. No.: 14/494,379

(22) Filed: Sep. 23, 2014

Related U.S. Application Data
(60) Provisional application No. 61/881,338, filed on Sep. 23, 2013.

(51) Int. Cl. G06F 3/041; G06F 3/0346

(52) U.S. Cl. CPC G06F 3/0414; G06F 3/0346; G06F 2203/04105
USPC 345/173

(57) ABSTRACT

A method for manipulating a remote device with a hand-held device having one or more first sensors to detect angular orientation of the device in one or more planes, and at least one two-dimensional surface device having one or more second sensors to detect translational position of the hand-held device in one or more directions, which communicates the angular orientation data from the hand-held device and the translational position data from the at least one surface device to the remote device, and positions the remote device based on the angular orientation data from the hand-held device and the translational position data from the at least one surface device.

### CROSS-REFERENCES TO RELATED APPLICATIONS

This application claims the benefit of U.S. Provisional Patent Application Ser. No. 61/881,338 filed Sep. 23, 2013, which is incorporated herein by this reference thereto.

### BACKGROUND OF THE INVENTION

1. Field of the Invention

The present invention is directed to remote control systems in which two or more degrees of freedom of the remote device is controlled by remote control, and, in particular, systems in which both angular and translational movement of the remote device is remotely controlled by a remote control.

2. Description of the Related Art

Motion sensors that provide 3-DOF rotational control have become largely available in the consumer market and can be found in almost all smartphones and other portable computing devices. Their ubiquity is due in large part to modern advances in MEMS technology that allow manufactures to fabricate miniaturized Inertial Measurement Units (IMUs) at a low cost and at a large scale. Besides key advancements in industrial engineering, what makes rotational measurements units convenient to design and produce is that the Earth's gravitational and magnetic fields provide a readily available global fixed coordinate frame for the sensing components to use a reference. As a result, many devices that measure 3-DOF include electromechanical components that respond to gravity's acceleration (e.g., accelerometers) and the direction of Earth's magnetic pole (e.g., magnetometers).

Conversely, devices that can measure full 6-DOF (3 rotational and 3 translational) are substantially more difficult to produce, partly because there is no global reference frame for 3D positions that is easy to exploit. For large-scale measurements of position, one can use triangulation afforded by geostationary satellites in the form of global positioning systems, but the measurements provided by this modality are not reliable for small-scale applications where robustness and accuracy are important. Commercially available solutions that can measure 6-DOF accurately at a small-scale are generally expensive, difficult to set up (complex and large physical footprints), and suffer from several limitations (e.g., cumbersome calibration procedures) that make them impractical for general users. Common examples include multi-camera optical tracking systems (e.g., Polaris® Vicra®) and magnetic systems (e.g., Polhemus™ Patriot).

The problem can be largely simplified by further constraining the degrees of freedom of the sensing unit if doing so makes sense for the application at hand. For instance, knowing that the translational motion of the device is constrained to a flat plane or the surface of a sphere can simplify the computations needed to correlate raw measurements to the physical configuration of the device, and can improve accuracy. Furthermore, the designer may separate the sensing units that measure translation and rotation. This way, not only the complexity of the apparatus decreases, but it allows reusing commercially available devices at consumer prices that already measure each component separately without the need of designing and manufacturing custom hardware. The invention presented in this document hinges on the latter. Furthermore, while users can use gravity (the down vector) as a clear guidance to orient a sensing device that provides three rotational or angular DOFs to control a nearby remote system, a clear physical reference does not exist for translational motion. By using a tablet endowed with a display as a surface for translation, we can display a clear visual reference to the user to guide the motion.

### SUMMARY OF THE INVENTION

One embodiment of the invention comprises a method for manipulating a remote device with a hand-held device having one or more first sensors to detect angular orientation of the device in one or more planes, and at least one two-dimensional surface device having one or more second sensors to detect translational position of the hand-held device in one or more directions, which communicates the angular orientation data from the hand-held device and the translational position data from the at least one surface device to the remote device, and positions the remote device based on the angular orientation data from the hand-held device and the translational position data from the at least one surface device.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

This invention presents a novel solution that allows a user to control a remote system in close proximity with three rotational or angular degrees-of-freedom (3-DOF), two translational degrees-of-freedom (2-DOF), and an optional compression component (1-DOF) for a total of six degrees-of-freedom (6-DOF). This device is useful for various applications where the user needs to control an object that is free to rotate around a movable pivot point, but the pivot point itself is constrained to move along a 2D surface. One notable application is the simulation of medical probes that must maintain constant contact with a patient's skin, such as ultrasound transducers. An important innovation introduced by this invention is that the tablet's display serves as a visual reference to guide the user as it attempts to control the application on the remote system. For example, the tablet may display the image of a virtual mannequin and the remote system show the image of a two-dimensional (2D) ultrasound slice. This way as the user applies touch to a body part on the tablet's display, he or she will see a corresponding ultrasound image of the same body part on the remote system.

The apparatus consists of: (1) a tablet device with a touch-sensitive surface, an embedded display, and support for wired or wireless connectivity; (2) a handheld device capable of measuring angular orientation that supports wired or wireless connectivity; (3) a remote system that hosts the application software and can exchange data with both the tablet and the handheld controller; (4) an optional pressure sensitive tip to measures the amount of mechanical pressure exerted (compression).

The handheld device preferably has a rubbery tip that can be detected by the touch sensitive surface and slides comfortably on it. The user places the tablet on a stable support such as a table or his own lap and slides the handheld motion controller on the surface of the tablet. By doing so, the motion controller relays three rotational DOFs in the traditional two orthogonally spaced planes, while the tablet relays the remaining two translational DOF in the traditional two orthogonally spaced directions to the remote system. If a pressure sensitive tip is available as part of the handheld motion controller, the system provides an additional one-DOF for compression. This apparatus provides a simple and inexpensive way for consumers to control a remote system with 6-DOF. Additionally, the tablet will display a reference for translational motion, thus offering a distinct advantage over alternative solutions for 5-DOF or 6-DOF sensing that do not provide any clear and adaptable reference to the user.

In the preferred embodiment, the problem of measuring the translational position and angular orientation of a device in 3D space is reduced from 6-DOF to 5-DOF by constraining the motion to a 2D surface, while retaining 3-DOF for rotations. The two translational components of the motion are measured by exploiting the touch surface of a tablet device such as the Apple® iPad or other popular Android™ devices. The rotational or angular components of the motion are measured by a low-cost handheld 3-DOF motion controller. Such devices are widely available and they generally operate by fusing measurements provided by various Inertial Measurements Units (IMUs) and other sensors, although they may rely on different operating principles, such as electromagnetic, optical, or mechanical positioning. However, the advantage of inertial sensors is that they do not require an external reference component to operate and they are preferable for compact and portable solutions.

By covering the tip of the handheld controller with a soft flexible cover with the appropriate material properties, the 3-DOF sensor can be simultaneously used as stylus to trace a path on the touch surface. Alternatively touch surfaces exist that do not require a special tip for sensing, such as 4-wire or 5-wire resistive displays similar to the one used in the popular Nintendo® DS and other low-cost touch sensitive devices. Alternatively, a regular stylus may be attached or incorporated with the handheld motion controller directly. A stylus has a narrow tip that may provide better feedback as to where the contact point between the controller and the touch surface is. Additionally, there are commercially available active styli that can relay richer positional information to the host tablet. Examples are the Wacom® Intuous® Creative Stylus for iOS or other styli designed specifically for certain Android™ devices, such as the Samsung® Galaxy Note®. In particular, the Wacom® Intuous® Creative Stylus has a pressure sensitive tip and can relay 2048 levels of compression through the host tablet via Bluetooth.

This invention allows a user to relay full 6-DOFs to a remote device with one smooth hand motion. Of course, each sensor needs to independently or cooperatively (separate sensors relay to the tablet and the tablet relays to the remote system) send its measurements to the remote host that runs the application software to be controlled by the apparatus. Many solutions are possible depending on the type of tablet and handheld controller used. For instance, the tablet may send touch positions via wi-fi and the handheld controller via Bluetooth.

This invention finds a natural application as a controller for medical simulations of ultrasound imaging, such as the SonoSim® Ultrasound Training Solution. The remote system in this case is either a laptop or desktop computer running the software. The remote system shows:

a. A 3D rendering of virtual body from the outside

b. A 3D rendering of an ultrasound probe placed on the region of the body that the user wishes to study

c. An overlay showing a reconstructed or simulated ultrasound image that matches the region of the body being swept by the rendered ultrasound probe

d. A UI that allows the user to interact with the application

The handheld motion controller combined with the tablet touch surface lets the user define the position and orientation of the virtual probe on the surface of the body in the software by altering its orientation and position within the tablet surface. Additionally, if pressure sensitivity is available it can be used to control the amount of compression applied against the virtual body, which in turn will cause soft tissues to deform in the simulation.

The invention presented in this document, allows the user to orient the virtual probe by means of the handheld 3-DOF rotational controller and to slide the probe along the surface of the body by translating and/or axially compressing the handheld controller on the surface of the tablet. Moreover, the tablet communicates with the remote system to establish which image to display when the user interacts with it. Preferably the tablet will display a top view of the part of the body that the user has selected. Since the physical extent of the tablet is known a priori, the tablet software can be designed so that the range of motion afforded by the user corresponds exactly to the extent on the body that he or she wishes to study.

While the present invention has been described with regards to particular embodiments, it is recognized that additional variations of the present invention may be devised without departing from the inventive concept.

What is claimed is:

1. A method for manipulating a remote ultrasound imaging system comprising:
providing a hand-held device having three first sensors to detect angular orientation of the device in three planes,
providing a two-dimensional surface of a personal computer table or laptop laid flat on a fixed counter or tabletop, said surface having two second sensors to detect translational position of the hand-held device in two directions,
displaying an image on said surface taken from the remote ultrasound imaging system,
providing a pressure sensor on or in the hand-held device to communicate compression data to the remote device,
communicating the angular orientation data and compression data from the hand-held device and the translational position data from the surface device to a remote host that controls the position and angular orientation of the remote device,
using the compression data to calculate translational position data in a dimension approximately orthogonal to the translational position data from the surface device, and
positioning a remote ultrasound imaging device based on the angular orientation data and pressure data from the hand-held device and the translational position data from the surface device.

2. A method for manipulating a remote device comprising:
providing a hand-held device having one or more first sensors to detect angular orientation of the device in one or more planes,
providing a two-dimensional surface device having one or more second sensors to detect translational position of the hand-held device in one or more directions,
communicating the angular orientation data from the hand-held device and the translational position data from the surface device to the remote device, and
positioning the remote device based on the angular orientation data from the hand-held device and the translational position data from the surface device.

3. The method of claim 2 further comprising, communicating the angular orientation data from the hand-held device and the translational position data from the surface device to the a remote host that is in communication with and control over the remote device.

4. The method of claim 2 wherein the two-dimensional surface is a touch screen of a personal computer tablet.

5. The method of claim 2 further comprising a providing a pressure sensor on or in the hand-held device to communicate pressure data to the remote device.

6. The method of claim 5 further comprising using the pressure data to communicate translational position data in a dimension approximately orthogonal to the translational position data from the surface device.

7. The method of claim 5, wherein the hand-held device has three first sensors to detect angular orientation of the device in three orthogonally spaced planes.

8. The method of claim 5, wherein the surface device has two second sensors to detect translational position of the hand-held device in two orthogonally spaced directions.

9. The method of claim 2 wherein the communication step is accomplished via wi-fi.

10. The method of claim 2 wherein the communication step is accomplished via Bluetooth.

11. The method of claim 2 wherein the remote device is a ultrasound system for use in medical procedures or simulations thereof.

12. The method of claim 2 further comprising displaying a portion of the remote environment on a display of the surface device.

13. The method of claim 2 further comprising adjusting the range of motion of the hand-held device over the surface so that the distance the hand-held device travels is approximately the same as the distance the remote device is made to travel.
